(19) United States
(12) Patent Application Publication
(10) Pub. No.: US 2013/0340940 A1
(43) Pub. Date: Dec. 26, 2013

(54) RF FEED LINE

(71) Applicant: TEL Solar AG, Trubbach (CH)

(72) Inventors: Peter HEISS, Zuerich (CH); Werner WIELAND, Malans (CH); Andreas BELINGER, Azmoos (CH); Stefan RHYNER, Buchs (CH)

(21) Appl. No.: 13/914,217

(22) Filed: Jun. 10, 2013

Related U.S. Application Data
(60) Provisional application No. 61/662,453, filed on Jun. 21, 2012.

(51) Int. Cl. H01P 3/00

(52) U.S. Cl. CPC H01P 3/003
USPC 156/345.48; 118/723 I; 333/238

(57) ABSTRACT

This disclosure relates to a flexible triplate stripline that can operate in temperatures of 150 C-250 C, flexible to move up/down with the top of a plasma reactor, and prevent plasma generation near the power transmission line in the stripline. The transmission line may be exposed to ambient conditions. The risk of generating plasma near the transmission line may be minimized by optimizing the height and width of the air gap adjacent to the transmission line and decreasing the voltage in a portion of the stripline by widening the transmission line.

### CROSS REFERENCE TO RELATED APPLICATIONS

This application claims priority to provisional application 61/662,453 filed on Jun. 21, 2012. The provisional application is incorporated by reference in its entirety into this application.

### TECHNICAL FIELD

This disclosure generally relates to systems and/or devices that provide power or current to a plasma-processing chamber.

### BACKGROUND

Plasma may be generated in a vacuum chamber by feeding electrical energy in the radio frequency range to ionize processes gases that may be enclosed in the vacuum chamber at sub-atmospheric pressures. Plasma processing may be used to etch a substrate or deposit a film on the substrate. The quality of the plasma processing may be based, at least in part, on the control of the plasma. In certain instances, controlling the location and uniformity of the plasma in the vacuum chamber may be desirable for substrate processing quality and/or limiting the impact of the plasma to desired regions of the vacuum chamber that may be beneficial for substrate processing or vacuum chamber longevity.

### BRIEF DESCRIPTION OF THE FIGURES

The features within the drawings are numbered and are cross-referenced with the written description. Generally, the first numeral reflects the drawing number where the feature was first introduced, and the remaining numerals are intended to distinguish the feature from the other notated features within that drawing. However, if a feature is used across several drawings, the number used to identify the feature in the drawing where the feature first appeared will be used. Reference will now be made to the accompanying drawings, which are not necessarily drawn to scale and wherein:

FIG. 1 is a simplified block diagram of a representative plasma processing system that may include a vacuum chamber and radio frequency (RF) feed line as described in one or more embodiments of the disclosure.

FIG. 2 is a cross sectional view of one embodiment of an RF feed line that provides power to an electrode as described in one or more embodiments of the disclosure.

FIG. 3 is a top view illustration of an RF feed line as described in one or more embodiments of the disclosure.

### SUMMARY

Embodiments of the invention are described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art.

Embodiments described in this disclosure may provide systems and apparatuses for providing power/current from a power source to a vacuum chamber used for plasma processing. The vacuum chamber may include an antenna that may transmit power to process gases inside the vacuum chamber. The power may ionize the process gases to generate plasma that may be used for etching a substrate or depositing a film on the substrate that has been placed in the vacuum chamber.

In one embodiment, the system may include a radio frequency (RF) feed line that transmits power from the power source to the antenna. Broadly, the RF feed line may include a transmission line that transmits power along the RF feed line, dielectric films that insulate the transmission line to prevent arcing, and grounding films that may ground the RF feed line. The RF feed line may be exposed to process gases in the vacuum chamber and the transmission line of the RF feed line may generate parasitic plasma that may degrade the etch/deposition process or components of the vacuum chamber that are exposed to the parasitic plasma. Parasitic plasma may be reduced by isolating the transmission line from the process gases. The isolation may involve shielding the transmission line with insulators or preventing the transmission line from arcing to the process gases by physical separation. Hence, the dimensions and materials of the RF feed line components may be based, at least in part, on the process power requirements and the ability to prevent parasitic plasma from being generated along the RF feed line.

In one embodiment, the RF feed line may include a transmission line, dielectric insulation, and grounding components that are formed by sheets or layers of their respective materials. The sheets or layers may be characterized by dimensions in which the length and width are substantially larger than the thickness of the sheets or layers. For example, in one specific embodiment, the length of the sheets or layers may be more than 500 mm; the width being more than 50 mm, and the thickness may range from 0.3 mm to 3 mm.

In this embodiment, the RF feed line may include a transmission layer that may be disposed between two dielectric layers that are disposed between two grounding layers. The layers may be secured together by clamps along the length of the RF feed line. In one specific embodiment, the overall thickness of the combined components (e.g., transmission layer, dielectric layers, and grounding layers) of the RF feed line may be less than 6 mm.

In another embodiment, the RF feed line may comprise two portions that may include different length and width dimensions. However, the thickness may be substantially similar throughout both portions. The differences in width may result in a voltage drop between the ends of the RF feed line to help reduce arcing or parasitic plasma along the RF feed line. For purposes of illustration, and not limitation, the RF feed line input voltage may be approximately 400V and the output voltage of the RF feed line may be approximately 100V. In another embodiment, the two portions of the RF feed line may be arranged at an angle to each other. For example, in one specific embodiment, the end of the first portion of the RF feed line may be coupled to second portion of the RF feed line at approximately a 90 degree angle. However, in other embodiments, the angle between the two portions may be more or less than 90 degrees.

Example embodiments of the disclosure will now be described with reference to the accompanying figures.

### DETAILED DESCRIPTION

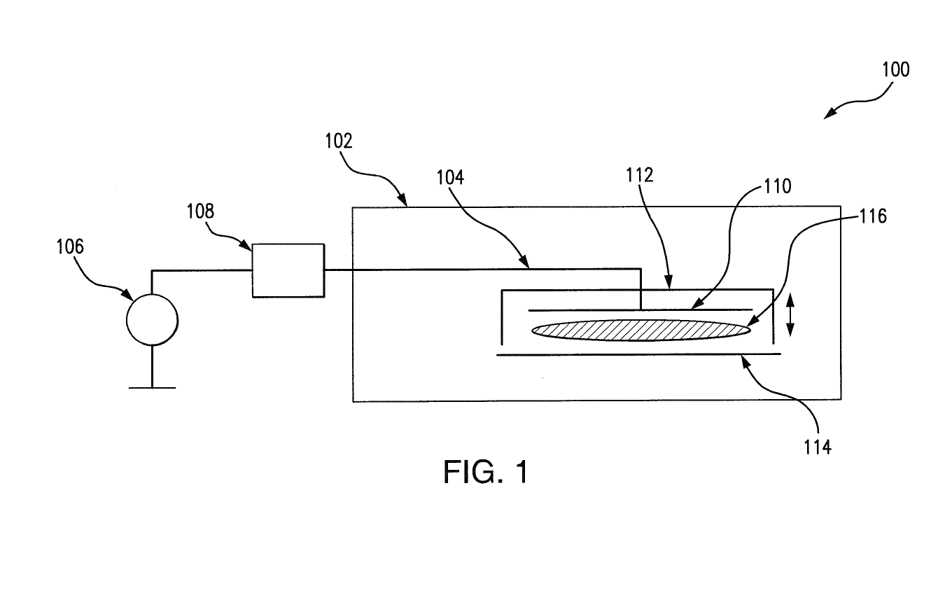

FIG. 1 is a simplified block diagram of a representative plasma processing system 100 that may include a vacuum chamber 102, a radio frequency (RF) feed line 104, a RF power source 106, and an RF matching component 108. The RF feed line 104 may be coupled to an electrode 110 disposed within a plasma chamber that may include an upper portion 112 and a lower portion 114. The plasma chamber may process a substrate 116 used for solar cells, organic light emitting diodes displays, and the like. The substrate may have at least one planar surface area of at least 1 m².

The vacuum chamber 102 may be an enclosure that surrounds the plasma chamber (e.g., 112, 114) and may be configured to create and control a sub-atmospheric pressure conditions. The vacuum chamber 102 may include a gas inlet port (not shown) that can receive process gases from a gas delivery system (not shown). The process gases may include, but are not limited to, Argon, Nitrogen, Hydrogen, Silane, Diborane, and the like. The vacuum chamber 102 may also include an exhaust port (not shown) that may be coupled to a pump (not shown). The exhaust port may be used to evacuate the processes gases from the vacuum chamber 102 and, in certain instances, the plasma chamber (e.g., upper portion 112 and lower portion 114).

The RF power source 106 may generate a repeating power signal at a desired frequency and power setting for a process condition. The frequency may range from ˜13 Mhz up to 1 Ghz and the power may range from 100 W to 5000 W.

The RF matching component 108 may match the impedance of the plasma chamber and the RF power source 106. The impedance matching may minimize the amount of reflected power from the plasma chamber. The impedance matching may also account for the impedance of the connections between the RF power source 106 and the plasma chamber.

The RF feed line 104 may be used to transfer power from the RF power source 106 to the electrode 110 in a way that minimizes the parasitic plasma being generated by the RF feed line 104 inside the vacuum chamber 102. In one embodiment, the RF feed line 104 may also compensate for thermal expansion effects caused by process temperatures in the vacuum chamber 102. For example, the components of the RF feed line 104 may be arranged to allow expansion of some components to relieve stress due to changes in component size. In another embodiment, the RF feed line 104 may also be designed to be flexible to enable the upper portion 112 of the plasma chamber to move in a vertical direction as shown by the arrow to the left of the upper portion 112 in FIG. 1.

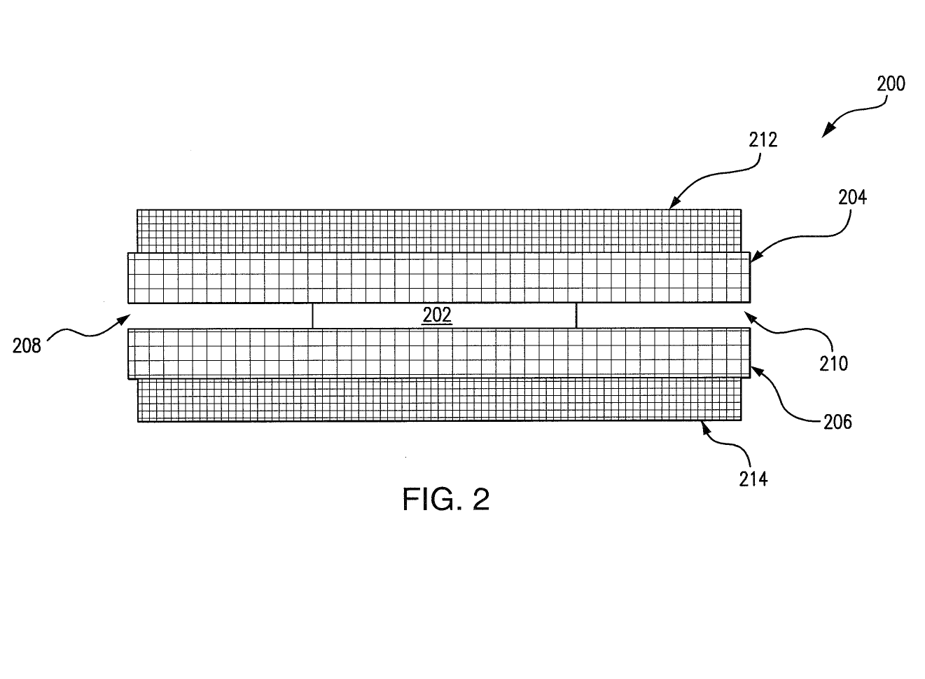

FIG. 2 is a cross sectional view 200 of one embodiment of the RF feed line 104 that provides power to the upper portion 112 of the plasma chamber. The cross sectional view 200 may illustrate the types of components in the RF feed line 104 and their respective arrangement. Broadly, the RF feed line 104 may use a transmission component 202 to transfer power between the RF power source/match 106, 108 and the electrode 110 of the plasma chamber. The RF feed line 104 may include an insulation component (e.g., upper insulator 204) to minimize arcing from the transmission component 202 to other components in the vacuum chamber 102. The RF feed line 104 may also include a grounding component (e.g., upper/lower ground 212/214) to ground the RF feed line 104.

In one embodiment, as shown in FIG. 2, the transmission component 202 may include a conductive material that enables the transmission of the power signal from the RF power source 106 to the upper portion 112 of the plasma chamber. The transmission component 202 may include, but is not limited to, gold, silver, copper, aluminum, metal alloys or any other conductive material. The transmission component 202 may be considered a live or hot wire that may arc without proper insulation. The insulation component(s) may be used to control arcing or discharges of current.

In this embodiment, the insulation component may include one or more elements to isolate the transmission component 202. By way of example and not limitation, the insulation component may include, but is not limited to, an upper insulator 204, a lower insulator 206, a first gap 208, and a second gap 210. In this case, the upper insulator 204 and the lower insulator 206 may comprise a dielectric material that bound or cover at least a portion of the transmission component 202. The thickness of the upper insulator 204 and the lower insulator 206 may be dependent on the skin depth related to the frequency of the power signal the resistivity of the upper insulator 204 and the lower insulator 206. The upper insulator 204 and the lower insulator 206 may include, but are not limited to, Polytetrafluoroethylene, Polyoxymethylene, or the like.

Gaps 208, 210 may also be used as a part of the insulation component to prevent arcing. For example, the gaps 208, 210 may be—depending on the pressure times gap distance product—large or small enough, to prevent arcing to nearby element and/or small enough to prevent nearby elements from reaching the transmission component 202. Further, the gaps 208, 210 may also be used to compensate for thermal expansion of other components of the RF feed line 104 during processing conditions or changes in temperature. For example, the transmission component 202 may thermally expand in the horizontal direction of the gaps 208, 210. In certain instances, the upper insulator 204 and the lower insulator 206 may expand horizontally and to narrow the gaps 208, 210 or to close off at least a portion of the gaps, such that at least portions of the upper insulator 204 and the lower insulator 206 may be in contact with each other. In other embodiments, the insulator component may include a single gap that to allow the insulator and transmission component 202 to expand. For example, the second gap 210 may not be used in the single gap embodiment.

In other embodiments, the gaps 208, 210 may be smaller than shown in FIG. 2. For example, the ends of the gaps 208, 210 may be closed or tapered by the upper insulator 204 and/or the lower insulator 206 to restrict the flow of gas into the gaps or to seal the gaps under process conditions as a result of thermal expansion of the RF feed line 104.

The RF feed line 104 may also include a grounding component to ground the RF feed line 104. In one embodiment, the grounding component may include an upper ground 212 and a lower ground 214 that are substantially flush or compressed against their respective insulators (e.g., upper insulator 204 and lower insulator 206), as shown in FIG. 2. The grounding component may comprise conductive materials that are in electrical communication with a ground for the system. The conductive materials may include, but is not limited to, silver, copper, tin, aluminum, metal alloys or the like.

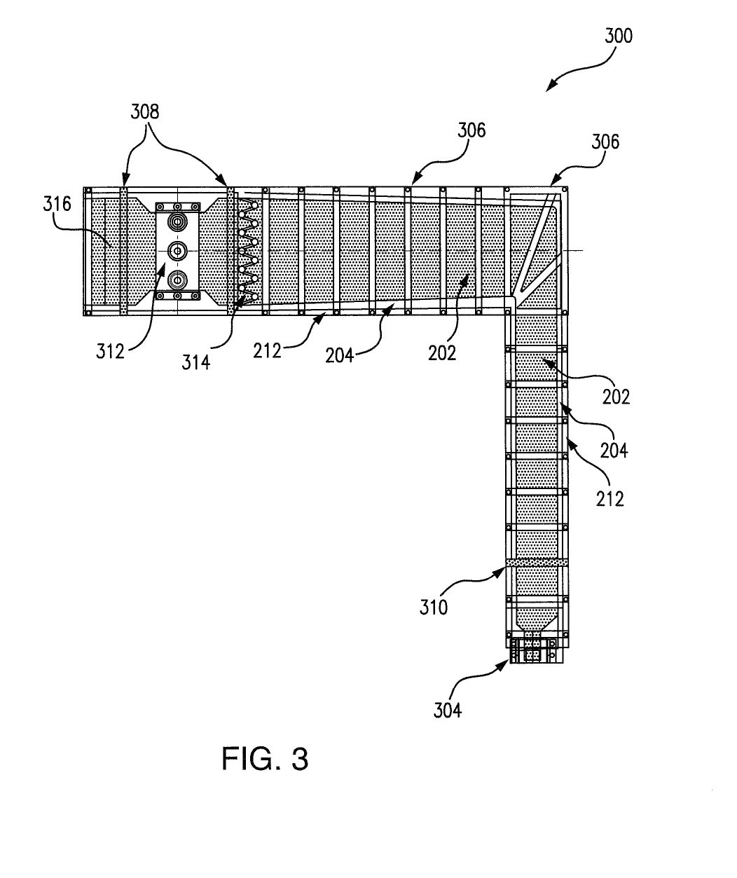

FIG. 3 is a top view illustration 300 of an RF feed line 104 that may include a similar arrangement as shown in the cross sectional view 200 in FIG. 2. However, for the purposes of illustration, the upper ground 212 and upper insulator 204 are shown in a transparent manner to illustrate the transmission component 202 in the middle of the RF feed line 104. As mentioned in the discussion of FIG. 1, the upper portion 112 of the plasma chamber may be moved in a vertical manner to facilitate the placement of the substrate 116. To accommodate the vertical movement, the RF feed line 102 may be flexible enough to allow either end to move by up to 80 mm. In one specific embodiment, the vertical movement may be approximately 50 mm. The RF feed line 104 components may be secured to each other via clamps 306. The clamps 306 may lightly secure the components to prevent moving in an unintended manner. For example, lightly secured may mean that the amount of compression by the clamps 306 is very slight and may enable the components to move or flex during vertical movements or thermal expansion. The RF feed line 104 may be secured to the RF power source 106 or RF matching component 108 via the incoming power connection 304 and secured to the electrode 110 by the outgoing power connection 312. The RF feed line 104 may also be secured to the vacuum chamber 102 via a secure clamp 310 and to the upper portion 112 of the plasma chamber via secure clamp 308. In one embodiment, the RF feed line 104 may also include an expansion component 314 that may offer additional capability to address thermal expansion of the RF feed line and the bending or flexing of the line during vertical movements. For example, a portion of the upper insulator 204 may include a break in continuity, as shown in FIG. 3, to facilitate thermal expansion or flexing. Further, the RF feed line 104 may also include a tuning stub 316 that may be used to optimize the impedance matching of the system. The tuning stub 316 will be described in the description of FIG. 4.

The components of the RF feed line 104 may include strips or layers of conductive or non-conductive materials arranged as shown in FIGS. 2 and 3. The strips or layers may be continuous for the entire span of the RF feed line 104 or they may include several parts for each component (e.g., transmission line 202, etc.). The non-continuous strips or layers may be coupled together, in contact with each other, or separated by a short distance of a few millimeters.

In one embodiment, the RF feed line 104 may include two portions that have different dimensions of the component parts (e.g., transmission line 202, etc.), as shown in FIG. 3. For example, the RF feed line 104 may include a first end portion configured to be coupled to an output of a RF power source 106 and a second end portion configured to be coupled to the electrode 110 of the plasma chamber housed within in the vacuum chamber. In one specific embodiment, the first end portion may be approximately 700-1000 mm long and 50-150 mm wide. More specifically, the first end portion may be approximately 760 mm long and approximately 135 mm wide. The second end portion may be approximately 900-1200 mm long and 200-300 mm wide. More specifically, the second end portion may be approximately 1060 mm long and approximately 280 mm wide.

The RF feed line 104 may also include a first outer conductive layer (e.g., upper ground 212) that has a first thickness and a first width that is greater the first thickness. A second conductive layer (e.g., lower ground 214) may include a second thickness and a second width that is greater than the second thickness. In one embodiment the corresponding widths and thicknesses of the first and second conductive layers may be similar. However, their width and thickness similarities are not required. In one specific embodiment, the first and second thicknesses of the first end portion may be 1-5 mm and the first and second widths may be 100-200 mm. In another specific embodiment, the first and second thicknesses may be approximately 1 mm and the first and second widths may be approximately 135 mm. The first and second thicknesses of the second end portion may be 1-5 mm and the first and second widths may be 250-300 mm. In one specific embodiment, the first and second thicknesses may be approximately 1 mm and the first and second widths may be approximately 280 mm.

The RF feed line 104 may also include an inner conductive layer (e.g., transmission line 202) that is disposed between the first and second outer conductive layers. The inner conductive layer may include a third thickness that is approximately less than 1 mm. In one specific embodiment, the third thickness may be approximately 0.3 mm. The third width of the inner conductive layer may be less the respective first width or the second width of the outer conductive layers. For example, the third width may be less than 100 mm in the first portion of the RF feed line 104 and less than 200 mm in the second portion of the RF feed line 104.

The RF feed line 104 may also include a first dielectric layer (e.g., upper insulator 204) that is disposed between the first outer conductive layer and the inner conductive layer. The first dielectric layer may have a fourth thickness and a fourth width. The fourth thickness may separate the first outer conductive layer and the inner conductive layer. In the first end portion, the fourth thickness may be 0.1-2 mm and the fourth width may be 80-120 mm. In one specific first end portion embodiment, the fourth thickness may be approximately 1 mm and the fourth width may be approximately 112 mm. In the second portion, the fourth thickness may be 0.1-2 mm and the fourth width may be 200-300 mm. In one specific first end portion embodiment, the fourth thickness may be approximately 1 mm and the fourth width may be approximately 257 mm.

The RF feed line 104 may also include a second dielectric layer (e.g., lower insulator 206) that is disposed between the second outer conductive layer and the inner conductive layer. The second dielectric layer may have a fifth thickness and a fifth width. The fifth thickness may separate the second outer conductive layer and the inner conductive layer. In the first end portion, the fifth thickness may be 0.1-2 mm and the fifth width may be 80-120 mm. In one specific first end portion embodiment, the fifth thickness may be approximately 1 mm and the fifth width may be approximately 112 mm. In the second end portion, the fifth thickness may be 0.1-2 mm and the fifth width may be 200-300 mm. In one specific first end portion embodiment, the fifth thickness may be approximately 1 mm and the fifth width may be approximately 257 mm.

The RF feed line 104 may also include a first gap (e.g., gap 208) disposed between the first and second dielectric layer and adjacent to a first side of the inner conductive layer. The first gap may comprise a sixth thickness that is approximate to the third thickness (e.g., inner conductive layer thickness). The RF feed line 104 may also include a second gap (e.g., gap 210) disposed between the first and second dielectric layer and adjacent to a second side of the inner conductive layer. The second gap may comprise a seventh thickness that is approximate to the third thickness (e.g., inner conductive layer thickness).

In one embodiment, the first and second portions of the RF feed line 104 may be orthogonal to each other, as shown in FIG. 3. However, the angle between the first and second portion may be up to 110 degrees. For example, the angle may be dependent on the placement of the upper portion 112 of the plasma chamber within the vacuum chamber 102. In another embodiment, the angle may include a radius of curvature that forms a smoother transition between the first and second portions in contrast to the orthogonal embodiment shown in FIG. 3.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation. In the use of such terms and expressions, there is no intention of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the claims. Although specific terms are employed herein, they are used in a generic and descriptive sense only, and not for purposes of limitation.

What is claimed:

1. A radio frequency (RF) power transmission line, comprising:
a first end portion configured to be coupled to an output of a RF generator;
a second end portion configured to be coupled to a plasma reactor housed within in a vacuum chamber;
a first outer conductive layer comprising:
a first thickness; and
a first width that is greater than the first thickness;
a second outer conductive layer comprising:
a second thickness; and
a second width that is greater than the second thickness;
an inner conductive layer that is disposed between the first outer conductive layer and the second outer conducting layer, the inner conductive layer comprising:
a third thickness; and
a third width that is less than the first width or the second width;
a first dielectric layer disposed between the first outer conductive layer and the inner conductive layer, and comprising:
a fourth thickness that separates the first outer conductive layer and the inner conductive layer; and
a fourth width that is greater than the fourth thickness;
a second dielectric layer disposed between the second outer layer and the inner conductive layer, and comprising:
a fifth thickness that separates the second outer conductive layer and the inner conductive layer;
a fifth width that is greater than the fifth thickness;
a first gap disposed between the first and second dielectric layer and adjacent to a first side of the inner conductive layer, and comprising a sixth thickness that is approximate to the third thickness; and
a second gap disposed between the first and second dielectric layer and adjacent to a second side of the inner conductive layer, and comprising a seventh thickness that is approximate to the third thickness.

2. The RF power transmission line of claim 1, wherein the fourth thickness and the fifth thickness are based, at least in part, on a frequency and power transmitted on the inner conductive layer, and the fourth width and the fifth width are based, at least in part, on limiting plasma from being generated in the first gap and the second gap proximate to the inner conductive layer.

3. The RF power transmission line of claim 1, wherein the first end portion and the second end portion are not aligned along a common axis.

4. The RF power transmission line of claim 1, wherein the first end portion can be moved vertically between a first position and a second position, the difference between the first position and the second position is up to 50 mm, and the second end portion can be moved vertically between a third position and a fourth position, the difference between the first position and the second position is up to 50 mm.

5. The RF power transmission line of claim 1, wherein the first thickness and the second thickness each comprise a thickness of at least 1 mm.

6. The RF power transmission line of claim 1, wherein the third thickness comprises a thickness of at least 0.3 mm.

7. The RF power transmission line of claim 1, wherein the fourth thickness and the fifth thickness each comprise a thickness of at least 1 mm.

8. The RF power transmission line of claim 1, further comprising a plurality of clamps that compress the first and second conductive layers together, the compression enabling free movement of the inner conductive layer caused by thermal expansion or vertical movement of the RF transmission line.

9. A system comprising:
a vacuum chamber;
a plasma reactor housed within the vacuum chamber, the plasma reactor comprising:
a plasma generating element for generating plasma; and
a processing chuck configured to handle a substrate of at least 1 m in width or length;
a Radio Frequency (RF) transmission line comprising:
a first end configured to be coupled to an output of a RF generator outside the vacuum chamber;
a second end configured to be coupled to said plasma generating element;
a first outer conductive layer comprising a first thickness and a first width;
a second outer conductive layer comprising a second thickness and a second width;
an inner conductive layer that is disposed between the first outer conducting layer and the second outer conducting layer, the inner conductive layer comprising:
a third thickness; and
a third width that is less than the first width or the second width;
a first dielectric layer disposed between the first outer conductive layer and the inner conductive layer, and comprising a fourth thickness that separates the first outer conductive layer and the inner conductive layer;
a second dielectric layer disposed between the second outer layer and the inner conductive layer, and comprising a fifth thickness that separates the second outer conductive layer and the inner conductive layer;
a first gap disposed between the first and second dielectric layer and adjacent to a first side of the inner conductive layer; and
a second gap disposed between the first and second dielectric layer and adjacent to a second side of the inner conductive layer.

10. The system of claim 9, wherein the plasma generating element is configured to operate at least at 40 MHz, and the vacuum chamber is configured to be maintained at pressure of up to 50 mBar and a temperature greater than or equal to 150 degrees Celsius.

11. The system of claim 9, wherein the RF transmission line further comprises:
a first portion that comprises the first end;
a second portion that comprises the second end, the second portion comprising a width that is greater than a width of the first portion.

12. The system of claim 9, further comprising a gas delivery system configured to deliver at least F₂ or NF₃ to the plasma reactor with the RF transmission line being exposed to at least F2 and NF3.

13. The system of claim 9, wherein the plasma reactor comprises a first plasma reactor and the RF transmission line comprises a first RF transmission line, and the system comprising a plurality of plasma reactors that are similar to the first plasma reactor, the plurality of plasma reactors comprising a corresponding RF transmission line that is similar to the first RF transmission line.

14. A radio frequency (RF) transmission line, comprising:
a first end comprising a chamber connector that can be coupled to a plasma chamber;
a second end comprising an input connector that can be coupled to a Radio Frequency (RF) matching system;
two outer conductive strips that are coupled electrically to each other and that extend at least between the first end and the second end;
two non-conductive strips disposed between the two or more outer conductive strips and that extend at least between the first end and the second end;
a transmission strip that enables electrical communication between the chamber connector and the input connector, the one or more transmission strips being electrically isolated from the two or more conductive strips by the two non-conductive strips; and
at least one gap between at least two of the non-conductive strips, the at least one gap being adjacent to the transmission strip and the at least one gap comprising a thickness that is substantially similar to a thickness of the at least one transmission strip.

15. The RF transmission line of claim 14, wherein each of the conductive strips comprise:
a first thickness that is less than or equal to 3 mm;
a first width that is greater than the thickness and less than or equal to 300 mm; and
a second width that is less than the first width.

16. The RF transmission line of claim 15, wherein the non-conductive strips comprise:
a second thickness that is less than or equal to 3 mm;
a third width that is greater than the thickness and less than or equal to 280 mm; and
a fourth width that is less than the third width.

17. The RF transmission line of claim 16, wherein the transmission strips comprise:
a third thickness that is less than or equal to 3 mm;
a fifth width that is greater than the thickness and less than or equal to 225 mm; and
a six width that is less than the fifth width.

18. The RF transmission line of claim 13, wherein the RF transmission line comprises at least one angle less than or equal to 100 degrees, the at least one angle forming an intersection between the first widths of the conductive strips, the non-conductive strips, and the transmission strips and the second widths of the conductive strips, the non-conductive strips, and the transmission strips.

19. The RF transmission line of claim 14, wherein the transmission strip further comprises an open end stub that optimizes the impedance of the transmission strip to be substantially similar to an impedance of the plasma chamber when the plasma chamber includes plasma.

20. The RF transmission line of claim 14, wherein the two non-conductive strips are substantially flush with the transmission strip and at least one of the conductive strips is substantially flush with one of the non-conductive strips.
